(19) United States
(12) Patent Application Publication
(10) Pub. No.: US 2006/0261230 A1
(43) Pub. Date: Nov. 23, 2006

(54) DEVICE FOR REMOVING DISEASED SURFACE TISSUES

(76) Inventor: Yi-Chang Lee, Taipei (TW)

Correspondence Address: LAW OFFICE OF LIAUH & ASSOC., 4224 WAIALAE AVE, STE 5-388, HONOLULU, HI, 96816, US

(21) Appl. No.: 11/164,400

(22) Filed: Nov. 21, 2005

Related U.S. Application Data
(63) Continuation of application No. 09/828,710, filed on Apr. 6, 2001.
(63) Continuation of application No. 10/388,844, filed on Mar. 14, 2003, now abandoned.

(51) Int. Cl. F16B 45/00

(52) U.S. Cl. 248/304

(57) ABSTRACT

A hanger for use on a metal rack, which has an upper and a lower horizontal metal bar extended across an upper and a lower end, respectively, of a vertical front edge thereof, includes an open-bottomed hook portion located at an upper end of the hanger, an open-bottomed engaging recess located closely below the hook portion, and a supporting seat located at a lower free end of the hanger. The hanger is connected to and hung from the metal rack by hooking the hook portion to the upper horizontal metal bar at the vertical front edge of the metal rack and engaging the engaging recess with the lower horizontal metal bar. A crossbar may be stably supported at each end on the supporting seat of one hanger for holding a plurality of suit hangers thereon.

### FIELD OF THE INVENTION

This is an continuation-in-part of Application Ser. No. 09/828,710, filed on 04/19/2004. The present invention relates to a hanger for use on metal rack, and more particularly to a hanger that can be directly hooked to a vertical front edge of a metal rack in a convenient manner. The present invention is a continuation in part application of U.S. Patent Application Ser. No. 09/828,710 filed on Apr. 19, 2004.

### BACKGROUND OF THE INVENTION

A metal rack is frequently fixed to a wall surface for holding things, so that valuable space in a room could be fully utilized without the need of spending a lot of money for a custom-made cabinet or closet. The metal rack may be covered with curtains or drapes to define a closed storage space and serves as, for example, a cabinet, a closet, or a wardrobe. When the metal rack is used as a wardrobe, it is desirable a crossbar may be fixed below the metal rack for holding some suit hangers.

FIG. 1 shows a conventional metal rack 10 that includes a vertically downward bent front to increase the structural strength of the metal rack 10, preventing the metal rack 10 from easy deformation. An upper and a lower horizontal metal bar 11, 12 are welded to an upper and a lower end, respectively, of the vertical front of the metal rack 10, such that a plurality of metal wires 13 forming the metal rack 10 are extended between the two horizontal metal bars 11, 12. FIG. 2 is an exploded perspective view of a conventional hanger 14 for use on the metal rack 10. The hanger 14 includes a box 15 provided at an upper end thereof and a supporting seat 16 connected to a lower free end thereof for supporting a crossbar 17 thereon (see FIG. 1). The box 15 includes an openable cover 18. Two lateral sidewalls of the box 15 are symmetrically provided with upper and lower recesses 151, 152 for the upper and the lower horizontal metal bars 11, 12 of the metal rack 10 to engage therewith before the cover 18 is closed to the box 15 with a screw and thereby locks the closed box 15 to the metal bars 11, 12 and connects the hanger 14 to the metal rack 10. The box 15 of the hanger 14 occupies a large volume and has complicate structure that necessitates relatively high manufacturing cost and causes inconveniences in connecting the hanger 14 to the metal rack 10.

U.S. Pat. No. 5,531,416 discloses a hanger having an upper edge adapted to hold to two metal wires on a top of a metal rack. The metal rack for use with the hanger disclosed in U.S. Pat. No. 5,531,416 must have two adjacent metal wires provided at a front end of the top of the metal rack, and is therefore inconvenient for use.

Generally, the metal rack is manufactured with low accuracy requirement, and it tends to have minor error in the space between two adjacent metal wires forming the metal rack. However, a position on the hanger for associating with the metal wires of the metal rack has fixed dimensions. Therefore, it is possible the hanger with fixed dimensions could not be fitly assembled to the metal rack that has errors in the size thereof.

### SUMMARY OF THE INVENTION

A primary object of the present invention is to provide a hanger that could be directly hooked to a vertical front edge of a metal rack and is therefore more convenient for use.

Another object of the present invention is to provide a hanger that could be assembled to a metal rack having errors in dimensions and is therefore more convenient for use.

To achieve the above and other objects, the hanger for use on metal rack according to the present invention includes an open-bottomed hook portion located at an upper end of the hanger, an open-bottomed engaging recess located closely below the hook portion, and a supporting seat located at a lower free end of the hanger. The hanger is connected to and hung from a metal rack by hooking the hook portion to an upper horizontal metal bar at a vertical front edge of the metal rack and engaging the engaging recess with a lower horizontal metal bar at the vertical front edge of the metal rack. A crossbar may be stably supported at each end on the supporting seat of one hanger for holding a plurality of suit hangers thereon.

The supporting seat defines an upper opening and a curve-sectioned channel, allowing a crossbar to force into the curve-sectioned channel via the upper opening.

In the present invention, an upper part of the hanger is provided along a profile thereof with a vertically extended slit to cut the upper part of the hanger into two laterally symmetric halves. The hanger is connected to the vertical front edge of the metal rack with the slit aligned and engaged with one metal wire at the vertical front edge of the metal rack, so that the hanger is restrained from moving laterally on the metal rack.

In the present invention, the hanger is provided below the engaging recess with an elastic latching member to normally elastically close a lower opening of the engaging recess, preventing the hanger from separating from the metal rack.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view showing the use of a conventional hanger on a metal rack;

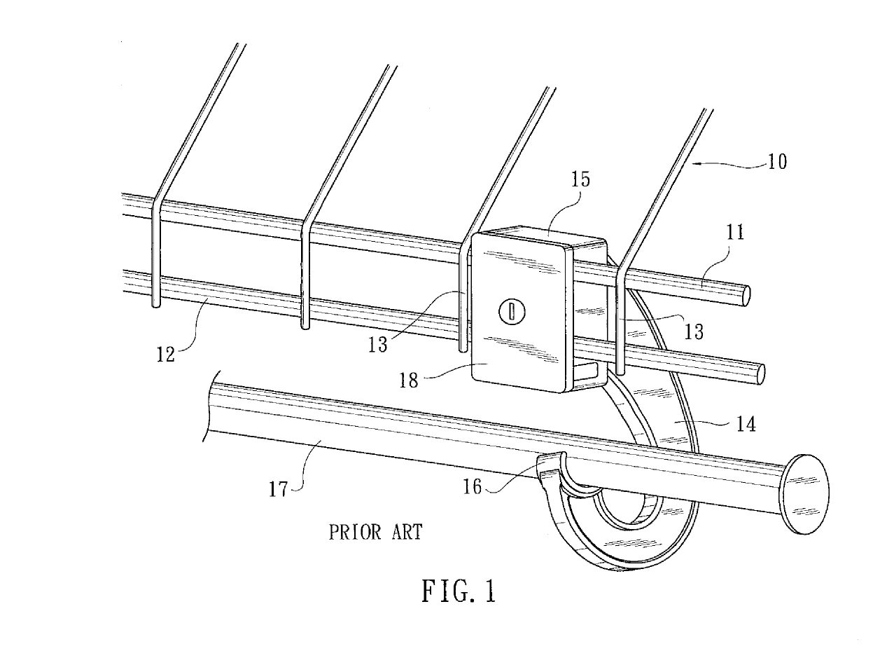

FIG. 2 is an exploded perspective view of the conventional hanger of FIG. 1;

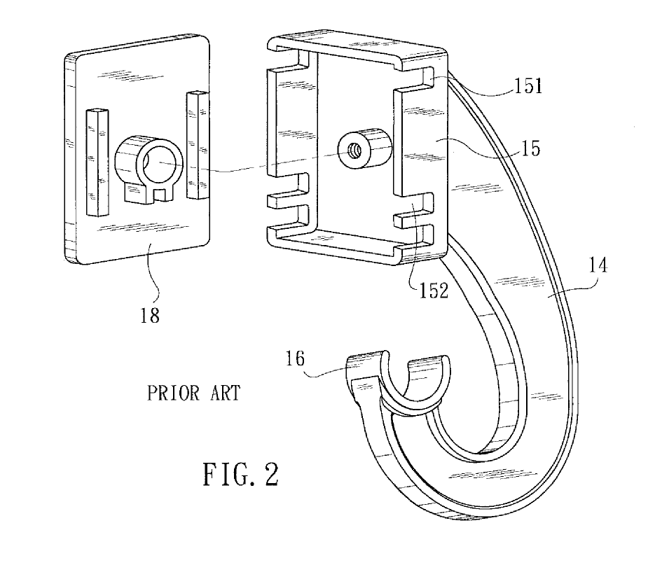

FIG. 3 is a perspective view of a hanger for use on metal rack according to an embodiment of the present invention;

FIG. 4 is a top perspective view showing the connection of the hanger of the present invention to a metal rack;

FIG. 5 is similar to FIG. 4 with a crossbar connected to the hanger on the metal rack;

FIG. 6 is a side view of FIG. 5;

FIG. 7 shows the hanger of the present invention is connected to the metal rack in another manner;

FIG. 8 is a perspective view of a hanger for use on metal rack according to another embodiment of the present invention;

FIG. 9 is a side view of the hanger of FIG. 8 in use; and

FIG. 10 is a fragmentary enlarged and sectioned side view of the hanger of FIG. 8.

### DETAILED DESCRIPTION OF THE PREFERRED EMBODIMENTS

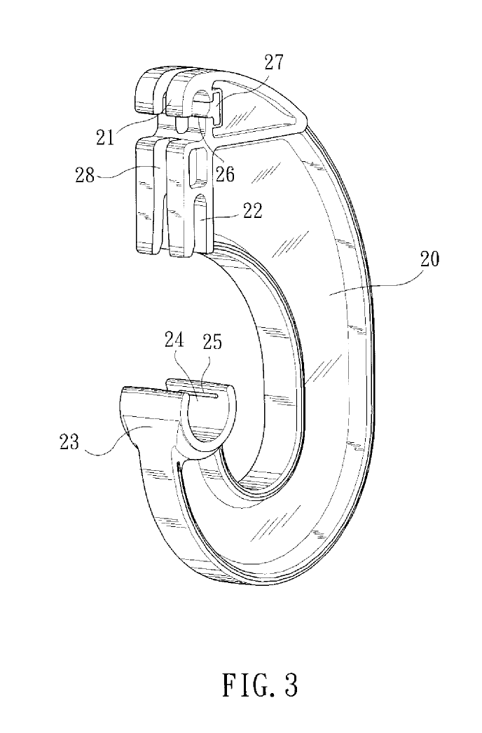

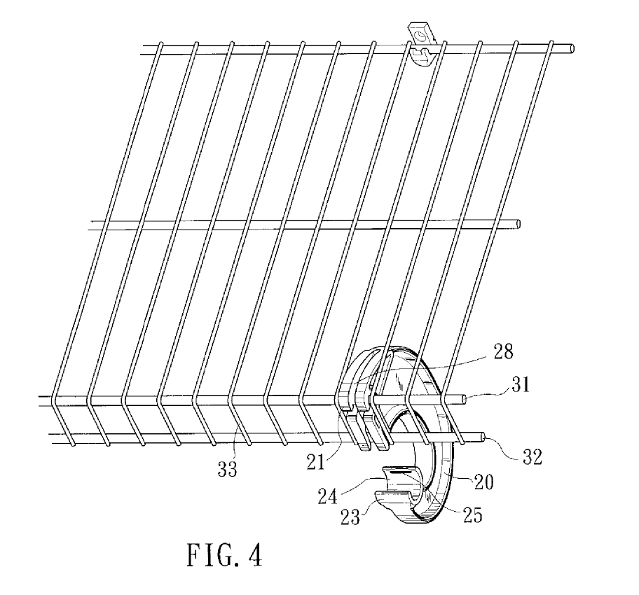

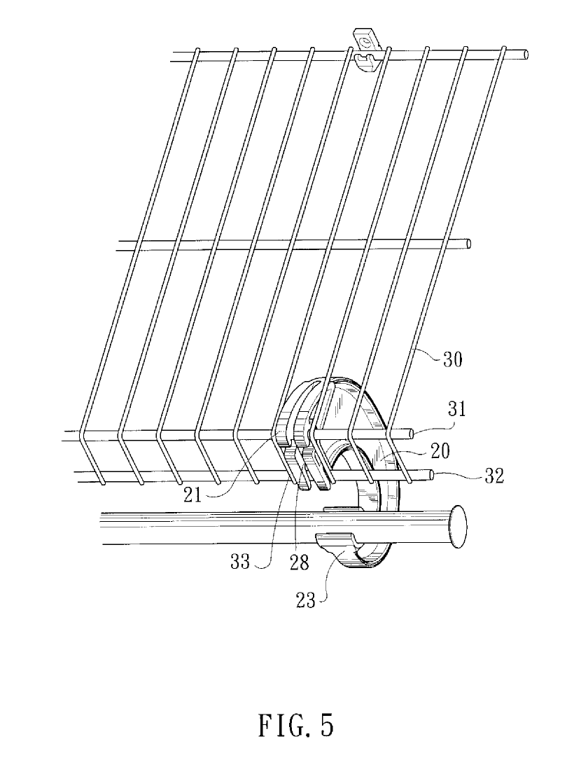

Please refer to FIG. 3 that is a perspective view of a hanger 20 according to the present invention for use on a metal rack 30 as shown in FIGS. 4 and 5. The metal rack 30 is a known structure adapted to fix to a wall surface using fastening means (not shown), such that a top of the metal rack 30 is in a horizontal position. As can be seen from FIGS. 4 and 5, a front end of the metal rack 30 is downward bent by 90 degrees to form a vertical front edge, and an upper and a lower horizontal metal bars 31, 32 are transversely welded to upper and lower end, respectively, of the vertical front edge to intersect with a plurality of metal wires 33 forming the metal rack 30.

Please refer to FIGS. 3, 4, and 5 at the same time. The hanger 20 is provided at an upper end with an open-bottomed hook portion 21, at a position closely below the hook portion 21 with a U-shaped open-bottomed engaging recess 22, and at a lower free end with a supporting seat 23. The hanger 20 is connected to the metal rack 30 by hooking the hook portion 21 to the upper horizontal metal bar 31 with the engaging recess 22 engaged with the lower horizontal metal bar 32.

The hook portion 21 hooked to the upper horizontal metal bar 31 of the metal rack 30 enables the hanger 20 to fixedly connect to the metal rack 30. The engaging recess 22 of the hanger 20 straddles the lower horizontal metal bar 32 to prevent the hanger 20 connected to the metal rack 30 from moving forward or backward. To connect the hanger 20 to the metal rack 30 for use, first cause the engaging recess 22 to straddle the lower horizontal metal bar 32, and then turn the hanger 20 about the lower horizontal metal bar 32 to a vertical position relative to the metal rack 30. Thereafter, pull the hanger 20 downward for the hook portion 21 to firmly engage with and therefore hook to the upper horizontal metal bar 31 of the metal rack 30.

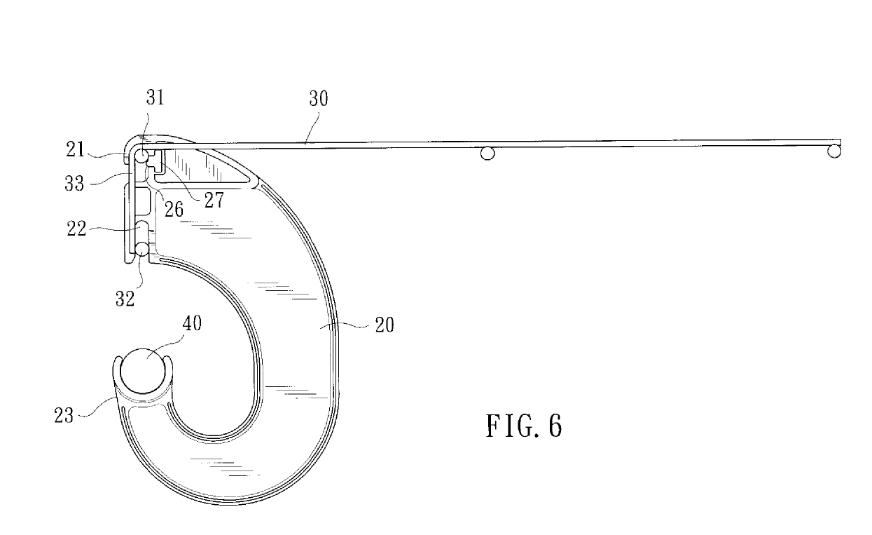

Please refer to FIGS. 5 and 6. The supporting seat 23 provided at the free end of the hanger 20 is open-topped to define a horizontally extended and curve-sectioned channel 24. It is possible to stably support a crossbar 40 on two hangers 20 by downward forcing two ends of the crossbar 40 into the horizontal channels 24 via upper openings of the supporting seats 23. The crossbar 40 supported at two ends on the hangers 20 may therefore be used to hold other suit hangers (not shown). The horizontal curve-sectioned channel 24 may be provided on an inner wall close to the upper opening with a horizontal rib 25. After the crossbar 40 is set in the horizontal channels 24 of two supporting seats 23, the ribs 25 in the horizontal channels 24 are pressed against an outer periphery of the crossbar 40, preventing the crossbar 40 from easily separating from the hangers 20 via the upper opening of the supporting seats 23.

As can be clearly seen from FIG. 6, the hook portion 21 of the hanger 20 is provided on an inner wall surface near the downward opening of the hook portion 21 with two forward protruded rib 26, so that the downward opening of the hook portion 21 is slightly smaller than an outer diameter of the upper horizontal metal bar 31. When the hook portion 21 of the hanger 20 is hooked to the upper horizontal metal bar 31, the ribs 26 enable the metal bar 31 to firmly set in the hook portion 21 without the risk of separating therefrom. More specifically, the hanger 20 is provided at two lateral ends with a soft gasket each. The gasket 27 is in the form of a lying letter T with a longitudinal part thereof extended forward to form the above-mentioned rib 26. When the upper horizontal metal bar 31 passes the downward opening of the hook portion 21, it compresses and deforms the ribs 26 to enter into the hook portion 21.

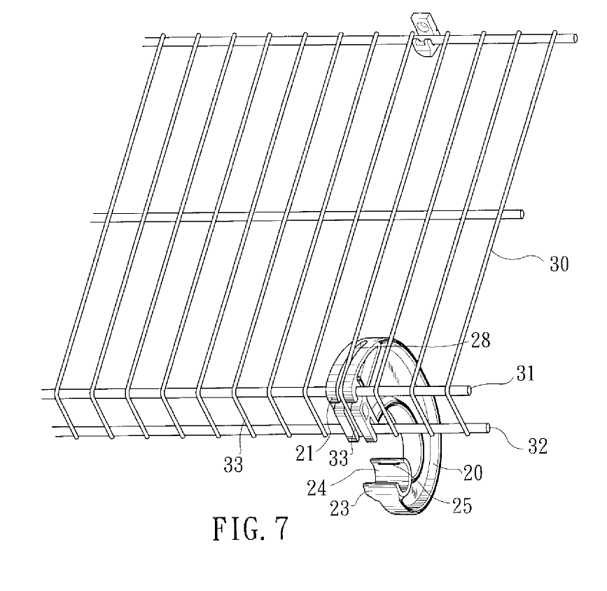

The hanger 20 is provided along a profile of an upper part, including the hook portion 21 and the engaging recess 22, with a vertically extended slit 28 to cut both the hook portion 21 and the engaging recess 22 into two laterally symmetric halves. Therefore, the hanger 20 may be connected to the upper and the lower horizontal bars 31, 32 of the metal rack 30 with the slit 28 aligned and engaged with one of the metal wires 33 located at the vertical front edge of the metal rack 30. The hanger 20 may then be fully connected to the metal rack 30 in the same manner as previously described. With the vertical metal wire 33 located in the slit 28, the hanger 20 is restrained from moving laterally on the metal rack 30, as shown in FIG. 7.

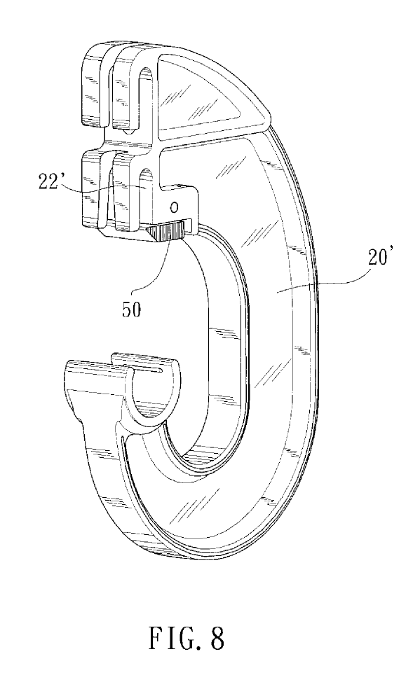

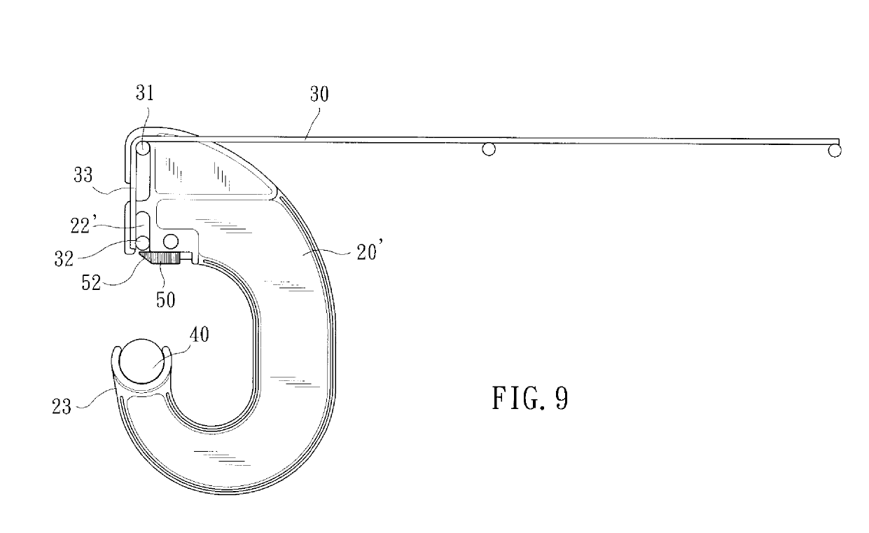

FIGS. 8 and 9 are perspective and side views, respectively, of a hanger 20′ according to another embodiment of the present invention. The hanger 20′ is generally structurally similar to the hanger 20, except for an elastic latching member 50 provided below the engaging recess 22′ of the hanger 20′ to openably close a downward opening of the engaging recess 22′. When the engaging recess 22′ straddles the lower horizontal metal bar 32 of the metal rack 30 and the hanger 20′ is subject to an upward force, the elastic latching member 50 stops the hanger 20′ from separating from the metal rack 30. An elastic element 51 is compressively mounted at a rear end of the latching member 50 to normally push the latching member 50 forward to close the downward opening of the engaging recess 22′. The latching member 50 has a beveled lower front end 52. When the lower horizontal metal bar 32 of the metal rack 30 is guided into the engaging recess 22′, it first contacts with and pushes against the beveled lower front end 52 of the latching member 50, causing the latching member 50 to elastically move backward to open the downward opening of the engaging recess 22, so that the lower horizontal metal bar 32 is admitted into the engaging recess 22′ and the hanger 20′ is properly connected to the metal rack 30.

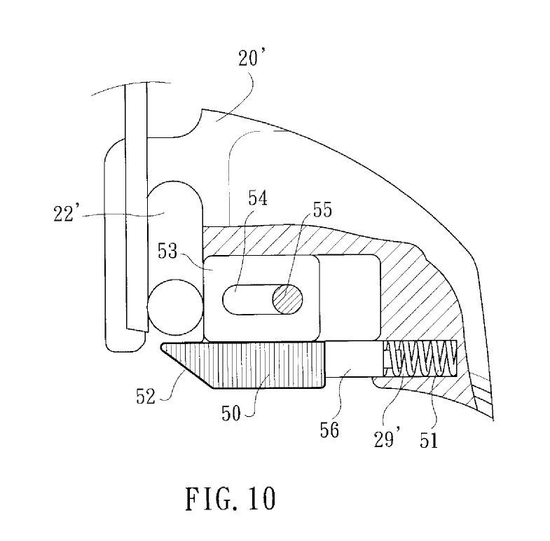

Please refer to FIG. 10 that shows the detailed structure of the elastic latching member 50. An upward extended plate 53 is connected to a top of the latching member 50 and has a horizontal long slot 54 formed thereon. A rivet 55 is extended through a hole (not shown) preformed on the hanger 20′ and the long slot 54 on the plate 53, so that the latching member 50 may be horizontally moved forward and backward relative to the hanger 20′.

The latching member 50 has a pin 56 projected from a rear end of the latching member 50 into a recess 29′ provided on the hanger 20′. The elastic element 51 is a compression spring mounted around the pin 56 in a compressed state to normally push the latching member 50 forward.

The hanger 20, 20′ may be integrally formed with a plastic material through injection molding, and can therefore be easily manufactured at reduced cost to be more competitive in the market. While the hanger 20, 20′ could be easily operated to quickly and conveniently connect to the metal rack 30, it may also be assembled to metal racks 30 having errors in the distance between the upper and the lower horizontal metal bars 31 and 32 to meet most general consumers' requirements.

What is claimed is:

1. A hanger for use on metal rack, said metal rack including a downward bent vertical front edge, an upper and a lower end of which are welded to an upper and a lower horizontal metal bar, respectively, so that a plurality of metal wires forming said metal rack perpendicularly intersect with and extend between said upper and lower horizontal metal bars, said hanger comprising an open-bottomed hook portion located at an upper end of said hanger, an open-bottomed engaging recess located closely below said hook portion, and a supporting seat located at a lower free end of said hanger; said supporting seat defining a horizontally extended, open-topped, and curve-sectioned channel, such that a crossbar may be forced into said curve-sectioned channel via an upper opening of said channel;
said hanger being connected to and hung from said metal rack by hooking said hook portion to said upper horizontal metal bar at said vertical front edge of said metal rack and engaging said engaging recess with said lower horizontal metal bar.

2. The hanger for use on metal rack as claimed in claim 1, further comprising an elastic latching member provided below said engaging recess to elastically close a lower opening of the engaging recess.

3. The hanger for use on metal rack as claimed in claim 2, wherein said latching member includes an elastic element compressively mounted behind said latching member to normally push said latching member forward to close said lower opening of said engaging recess.

4. The hanger for use on metal rack as claimed in claim 2, wherein said latching member includes a beveled lower front end.

5. The hanger for use on metal rack as claimed in claim 2, wherein said latching member has an upward projected plate connected to a top of said latching member, and said plate has a horizontal long slot formed thereon; a rivet being extended through a hole preformed on said hanger and said horizontal long slot on said plate, allowing said latching member to horizontally move forward or backward relative to said hanger.

6. The hanger for use on metal rack as claimed in claim 1, wherein said hook portion of said hanger is provided on an inner wall surface near a downward opening of said hook portion with two forward protruded ribs, so that the downward opening of said hook portion is slightly smaller than an outer diameter of said upper horizontal metal bar of said metal rack.

7. The hanger for use on metal rack as claimed in claim 6, wherein said hanger is provided at two lateral ends with a soft gasket each, said gasket being in the form of a lying letter T with a longitudinal part thereof extended forward to form said forward protruded rib.

8. The hanger for use on metal rack as claimed in claim 1, wherein said horizontal channel of said supporting seat is provided on an inner wall close to said upper opening of said supporting seat with a horizontal rib, preventing said crossbar from easily separating from said hanger via said upper opening of said supporting seat.

9. The hanger for use on metal rack as claimed in claim 1, wherein said hanger is provided at an upper part along a profile thereof with a vertically extended slit to cut both said hook portion and said engaging recess into two laterally symmetric halves.
